(19) United States
(12) Patent Application Publication
(10) Pub. No.: US 2019/0080819 A1
(43) Pub. Date: Mar. 14, 2019

(54) LOW-SMOKE, HALOGEN-FREE FLEXIBLE CORDS

(71) Applicant: General Cable Technologies Corporation, Highland Heights, KY (US)

(72) Inventors: Carlos Augusto Ospina Ramirez, Bogota (CO); Lens Alfonso Roa Vega, Bogota (CO)

(21) Appl. No.: 16/129,288

(22) Filed: Sep. 12, 2018

Related U.S. Application Data
(60) Provisional application No. 62/557,278, filed on Sep. 12, 2017.

(51) Int. Cl. H01B 3/42; H01B 7/295

(52) U.S. Cl. CPC H01B 3/427; C08L 23/06; H01B 7/295

(57) ABSTRACT

Halogen-free flexible cords are disclosed. The cables include one or more conductors, each surrounded by an insulation layer and a nylon layer. The flexible cords exhibit low smoke when burned. Methods of making and using the cables are also disclosed.

### REFERENCE TO RELATED APPLICATIONS

The present application claims the priority of U.S. provisional application Ser. No. 62/557,278, entitled LOW-SMOKE, HALOGEN-FREE FLEXIBLE CORDS, filed Sep. 12, 2017, and hereby incorporates the same application herein by reference in its entirety.

### TECHNICAL FIELD

The present disclosure generally relates to non-toxic flexible cords formed with very low halogen content and exhibiting low-density, and low-corrosion, smoke when burned.

### BACKGROUND

Flexible cords, or flexible cables, are useful to provide power in commercial, industrial, and residential applications. For example, flexible cords can offer benefits such as easy positioning of the cords, simplified routing, and portability. Such benefits can make flexible cords useful as an extension cord, as an appliance cord, and as cables for power tools and lighting. However, conventional flexible cords are formed of halogenated materials which can release toxic gases when burned. Conventional flexible cords can also release large quantities of smoke when burned. Cables formed of non-halogenated insulation layers and coverings are safer to use.

### BRIEF DESCRIPTION OF THE DRAWINGS

FIG. 1 depicts a cross-sectional view of a flexible cord having four conductors according to one embodiment.

FIG. 2 depicts a cutaway side view of the flexible cord of FIG. 1.

### SUMMARY

According to one embodiment, a cable includes one or more conductors and a jacket layer surrounding the one or more conductors. Each of the one or more conductors includes an insulation layer surrounding the conductor and a nylon layer surrounding the insulation layer. The cable is halogen-free and passes one or more of International Electrotechnical Comission (“IEC”) 612-34-2 and IEC 60751-1-2.

According to another embodiment, a method of forming a cable includes providing one or more conductors, extruding an insulation layer around each of the one or more conductors, extruding a nylon layer around each of the insulation layers, and applying a jacket layer substantially around the one or more conductors. The cable is halogen-free and passes one or more of International Electrotechnical Comission (“IEC”) 612-34-2 and IEC 60751-1-2.

### DETAILED DESCRIPTION

Flexible cords, or flexible cables, constructed without the use of halogenated compounds and which exhibit low smoke when burned are disclosed. The flexible cords can be used in place of conventional flexible cords to provide enhanced safety and to comply with stringent fire requirements. Generally, the flexible cords described herein can include one or more conductors each surrounded by an insulation layer and a nylon layer, and a cable jacket surrounding the one or more conductors.

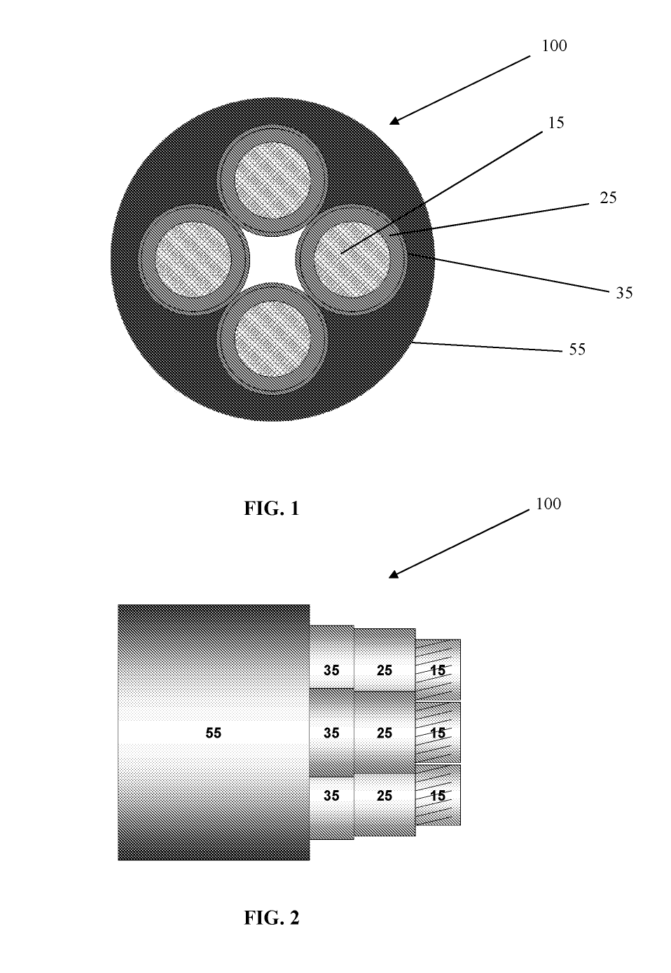

Selected embodiments of a flexible cord in accordance with the present disclosure are now described herein in connection with the views and examples of FIGS. 1 and 2, wherein like numbers indicate the same or corresponding elements throughout the views.

FIGS. 1 and 2 depict a cross-sectional view and cutaway side view respectively of a flexible cord 100 including four conductors 15 according to one embodiment. Each conductor 15 is surrounded by an insulation layer 25 and a nylon layer 35 respectively. The flexible cord 100 further includes a cable jacket 55 surrounding all four of the conductors 15.

As can be appreciated, the flexible cords described herein can vary from the example flexible cord depicted in FIGS. 1 and 2. For example, the flexible cords described herein can any include any number of conductors. In certain embodiments, the flexible cords can include two conductors, three conductors, four conductors, or five conductors to facilitate use of the flexible cord in a variety of common applications. For example, flexible cords for appliances and extension cords commonly include two, three, or four conductors. As can be appreciated however, greater, or fewer, numbers of conductors can alternatively be included in a flexible cord in certain embodiments.

As can be further appreciated, other variations are also possible. For example, a flexible cord can include, in certain embodiments, a cable shield to improve the electrical properties of the cord or to minimize any interference caused by the cord. In certain embodiments, a cable separator can also be included to separate the conductors.

As will be appreciated, a variety of halogen-free materials can be used to form each of the individual components of a flexible cord (e.g., the conductors 15, insulation layers 25, nylon layers 35, and cable jacket 55).

For example, the conductor, or conductive element, of a flexible cord, can generally be formed of any suitable electrically conductive metal such as, copper, aluminum, a copper alloy, an aluminum alloy (e.g. an aluminum-zirconium alloy), or any other conductive metal. As will be appreciated, the conductor can be solid, or can be twisted and braided from a plurality of smaller conductors. In certain embodiments, a braided conductor can advantageously be selected to increase the electrical conductivity and flexibility of the cord compared to a similar cord formed with solid conductors. In certain embodiments, the conductors can comply with the requirements of American Society for Testing and Materials (“ASTM”) standard B174. In certain such embodiments, the braided conductors can comply with Section J of ASTM B174, or equivalent such as IEC 60228.

Generally, each conductor can be of any suitable wire gauge. For example, in certain embodiments, the conductors can be sized in accordance to American Wire Gauge (“AWG”) standards and each conductor can have a size between 6 AWG and 24 AWG. As can be appreciated, equivalent international gauges, such as those expressed in square mm, can alternatively be suitable. As can be appreciated, selection of the wire gauge can vary depending on factors such as the desired cable operating distance, the desired electrical performance, and physical parameters such as the thickness of the cable. Cables with increased ampacity or voltage requirements can require thicker gauge conductors but can be less flexible as a result.

Each conductor is generally surrounded by an insulation layer formed from any of a variety of suitable halogen-free materials such as polyolefin polymers, polyolefin copolymers, and non-halogenated thermoplastic rubbers. For example, each insulation layer can be formed of polyethylene such as low-density polyethylene (“LDPE”), high-density polyethylene (“HDPE”), high-molecular weight polyethylene (“HMWPE”), ultra-high molecular weight polyethylene (“UHMWPE”), linear low-density polyethylene (“LLDPE”), very low-density polyethylene, and cross-linked polyethylene (“XLPE”); polypropylene; ethylene copolymers such as ethylene-octene copolymer or ethylene vinyl acetate copolymer (“EVA”); or a halogen-free thermoplastic rubber.

Surrounding an insulation layer with a nylon layer can allow for the insulation layers to have relatively thin cross-sections compared to comparative halogen-free insulation layers. Each insulation layer can have a thickness of about 0.1 mm to about 10 mm in certain embodiments, about 0.2 mm to about 5 mm in certain embodiments, or about 0.35 mm to about 2.00 mm in certain embodiments.

As will be appreciated, inclusion of a nylon layer can allow the flexible cords described herein to exhibit similar dimensions as conventional flexible cords constructed from halogenated materials such as polyvinyl chloride (“PVC”). Generally, inclusion of a nylon layer can impart such benefits by providing mechanical strength to the insulation layer and reducing the need for the insulation layer to independently exhibit sufficient mechanical strength. Generally, any halogen-free nylon (e.g., polyamide) can be suitable to form a nylon layer.

In certain embodiments however, it can be particularly advantageous to select a halogen-free nylon which exhibits both strong fire retardant properties and desirable mechanical properties. For example, nylon 6-6 and nylon 6 can both be particularly advantageous because such nylons can exhibit high flame retardance as well as high mechanical strength, stability, and heat and chemical resistance. As can be appreciated however, other polyamide materials can also be suitable.

In certain embodiments, the nylon layer can be relatively thin and can have a thickness of about 0.01 mm to about 1 mm, about 0.05 mm to about 0.5 mm, or about 0.1 mm to about 0.25 mm.

A nylon layer can also provide other benefits. For example, the durability and strength of nylon can improve the stripability of the flexible cords described herein.

The cable jacket, surrounding the conductor assemblies, can generally be formed from any of the halogen-free materials previously described as being suitable for the insulation layers. For example, suitable cable jackets can be formed of a polyolefin (e.g., polyethylene) or a thermoplastic rubber in certain embodiments. In certain embodiments, the cable jacket can have a thickness of about 0.5 mm to about 5 mm, about 0.6 mm to about 3.5 mm, or about 0.76 mm to about 2.54 mm.

As can be appreciated, the insulation layer, nylon layer, and cable jacket can be modified in a variety of ways. For example, various additives and fillers can be added to influence the mechanical and electrical properties of the flexible cord. Generally, each such additive and filler can be halogen-free. In certain embodiments, additives and fillers can include crosslinking agents and initiators, colorants, processing agents, antioxidants, additional polymers, and stabilizers.

According to certain embodiments, a colorant can be added to one or more layers of the flexible cord. Suitable colorants can include, for example, carbon black, cadmium red, iron blue, or a combination thereof. As can be appreciated, any other known colorant can alternatively be added.

A processing aid can be included to improve the processability of the flexible cord by forming a microscopic dispersed phase within a polymer carrier. During processing, the applied shear can separate the processing aid (e.g., processing oil) phase from the carrier polymer phase. The processing aid can then migrate to the die wall to gradually form a continuous coating layer to reduce the backpressure of the extruder and reduce friction during extrusion. The processing oil can generally be a lubricant, such as ultra-low molecular weight polyethylene (e.g., polyethylene wax), stearic acid, silicones, anti-static amines, organic amities, ethanolamides, mono- and di-glyceride fatty amines, ethoxylated fatty amines, fatty acids, zinc stearate, stearic acids, palmitic acids, calcium stearate, zinc sulfate, oligomeric olefin oil, or combinations thereof.

In certain embodiments, a processing oil can alternatively be a blend of fatty acids, such as the commercially available products: Struktol® produced by Struktol Company of America (Cuyahoga Falls, Ohio), Akulon® Ultraflow produced by DSM N.V. (Birmingham, Mich.), MoldWiz® produced by Axel Plastics Research Laboratories (Woodside, N.Y.), and Aflux® produced by Rhein Chemie Corp. (Chardon, Ohio).

In certain embodiments, the flexible cord can alternatively be substantially free of any lubricant, processing oil, or processing aids. As used herein, “substantially free” means that the component is not intentionally added, or alternatively, that the component is not detectable with current analytical methods.

According to certain embodiments, suitable antioxidants for inclusion in a flexible cord can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis[3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5-bis(1,1-dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-branched alkyl ester, 2,4-dimethyl-6-t-butylphenol tetrakis{methylene-3-(3′,5′-ditert-butyl-4′-hydroxyphenol)propionate}methane or tetrakis{methylene3-(3′,5′-ditert-butyl-4′-hydrocinnamate}methane, 1,1,3tris(2-methyl-4-hydroxyl-5-butylphenyl)butane, 2,5,di t-amyl hydroquinone, 1,3,5-tri methyl2,4,6tris(3,5di tert butyl-4-hydroxybenzyl)benzene, 1,3,5tris(3,5 di-tert-butyl-4-hydroxybenzyl)isocyanurate, 2,2-methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis{3-(3-t-butyl-4-hydroxy-5methylphenyl)propionate}, 1,3,5-tris(4tert-butyl-3-hydroxy-2,6-dimethylbenzyl)-1,3,5-triazine-2,4,6-(1H,3H, 5H)trione, 2,2-methylenebis {6-(1-methylcyclohexyl)-p-cresol}; sterically hindered phenolic antioxidants such as pentaerythritol tetrakis(3-(3,5-di-tert-butyl-4-hydroxyphenyl)propionate); hydrolytically stable phosphite antioxidants such as tris(2,4-di-tert-butylphenyl)phosphite; toluimidazole, and/or sulfur antioxidants, such as bis(2-methyl-4-(3-n-alkylthiopropionyloxy)-5-t-butylphenyl)sulfide, 2-mercaptobenzimidazole and its zinc salts, pentaerythritol-tetrakis(3-lauryl-thiopropionate), and combinations thereof.

In certain embodiments, a stabilizer can be included to improve the compatibility of the components included in a flexible cord. In such embodiments, suitable stabilizers can include mixed metal stabilizers such as those based on calcium and zinc chemistries. For example, a calcium hydroxide metal stabilizer or a calcium-zinc metal carboxylate stabilizer can be used in certain embodiments. In certain embodiments, commercial stabilizers such as Therm-Chek® stabilizers produced by Ferro Corp. (Mayfield Heights, Ohio) can also be used.

In certain embodiments, the flexible cords described herein can also be substantially free of any additives or fillers and can include, for example, only colorants.

Generally, the flexible cords described herein can be formed using an extrusion process. In a typical extrusion method, an optionally heated conductor can be pulled through a heated extrusion die, such as a cross-head die, to apply a layer of melted composition onto the conductor. Upon exiting the die, if the composition is adapted as a thermoset composition, the conducting core layer may be passed through a heated vulcanizing section, or continuous vulcanizing section and then a cooling section, such as an elongated cooling bath, to cool. Multiple layers (e.g., insulation layer and the nylon layer) can be applied through consecutive extrusion steps in which an additional layer is added in each step. Alternatively, with the proper type of die, multiple layers of the composition can be applied simultaneously. In certain embodiments, the cable jacket can be extruded around the assembly of conductors. In other certain embodiments, a preformed cable jacket can be pulled around the assembly of conductors.

As will be appreciated, the flexible cords described herein can exhibit advantageous electrical and mechanical properties particularly when compared to conventional flexible cords and known halogen-free flexible cords. For example, the flexible cords described herein can have a similar cable diameter, weight, bending radius, and electrical carrying capacity (e.g., voltage and ampacity) as a conventional flexible cord formed of halogenated materials while also meeting the low-smoke and zero-halogen requirements of International Electrotechnical Commission (“IEC”) 612034-2 and 60754-1-2 respectively. Passing such properties can allow flexible cords to be used in crowded areas where toxic gases and smoke would present a serious danger to life and health. For example, the halogen-free and low-smoke properties of the flexible cords described herein can allow the cords to be used in Colombia in areas with fifty or more people because such flexible cords meet Section 518 of NTC 2050 (Colombia). Section 518 of NTC 2050 requires cables to exhibit low-smoke when burned and be halogen-free.

In certain embodiments, the flexible cords described herein can also pass stringent fire resistance qualifications such as the Underwriter's Laboratory (“UL”) 1581 VW-1 flame test. The VW-1 vertical flame tests require cables to extinguish a flame within 60 seconds after a specified flame is applied to the cable. Additionally, a paper sample located above the cable must not catch on fire. Samples are required to pass at least 3 consecutive samples to pass the respective flame tests.

As can be appreciated, such advantageous properties can enable the flexible cords to be used to be in a variety of applications requiring flexible cords or cables. For example, the flexible cords described herein can be suitable for use as an extension cord, an appliance cord, or as a cord for any other application requiring flexibility or portability. In certain embodiments, the flexible cords described herein can be suitable for applications requiring about 5 volts to about 1,000 volts. As can be appreciated however, the flexible cords described herein can be particularly advantageous for low-power (e.g., 120 volt) applications. In other embodiments, the flexible cords can be suitable for applications requiring about 600 to about 1,000 volts.

### Examples

Table 1 depicts the properties of three Example flexible cords including three conductors each. Examples 1 and 2 are comparative flexible cords. Specifically, the flexible cord of Example 1 is designed according to UL 83 standards and includes conductors surrounded by an insulation layer formed of polyvinyl chloride and a nylon layer. The cable jacket of Example 1 is polyvinyl chloride. The flexible cord of Example 2 is designed according to NTC 6182 standards (Colombia) and includes conductors surrounded by a halogen-free insulation layer and a polyester tape. The cable jacket of Example 2 is halogen-free. Example 3 is an inventive flexible cord. Each conductor of Example 3 includes a halogen-free insulation layer and a nylon layer. The cable jacket is halogen-free.

In Table 1, Ampacity and Maximum Operating Voltage were determined in accordance to UL 62 and UL 2556 based on the conductors direct current resistance, insulation aging, insulation thickness, and voltage withstand test. The Max Pulling Tension was determined from the tensile strength and cross sectional area in accordance to ASTM B3 and UL 2556. The Minimum Bending Radius was determined in accordance to Insulated Cable Engineers Association (“ICEA”) S-95-658.

TABLE 1

| | Example 1 | Example 2 | Example 3 |
|---|---|---|---|
| Diameter (mm) | 9.0 | 10.2 | 9.0 |
| Weight (kg/km) | 154.7 | 184.6 | 153.2 |
| Ampacity at 60° C. | 20 | 20 | 20 |
| (A) | | | |
| Max Operating | 600 | 600 | 600 |
| Voltage (volts) | | | |
| Max Pulling Tension | 460 | 460 | 460 |
| (kg) | | | |
| Minimum Bending | 36 | 41 | 36 |
| Radius (mm) | | | |
| Conductor Standard | ASTM B174 | ASTM B174 | ASTM B174 |
| Low-Smoke (IEC | No | Yes | Yes |
| 612034-2) | | | |
| Halogen-Free (IEC | No | Yes | Yes |
| 60754-1-2) | | | |
| Flame Retardancy | Very good | Good | Good |

As illustrated by Table 1, Example 3, the inventive flexible cord, exhibited superior properties when compared to comparative Examples 1 and 2. For example, the flexible cord of Example 3 maintained the desirable electrical and physical properties of Example 1 without the detriments observed in the halogen-free flexible cord of Example 2. The minimum bending radius was four times the diameter of each of the example cables.

As can be appreciated, the flexible cords described herein can be safer than conventional flexible cords. For example, conventional flexible cords can include halogenated compounds which emit toxic gases when burned.

As used herein, all percentages (%) are percent by dry weight of the total composition, also expressed as weight/weight %, % (w/w), w/w, w/w % or simply %, unless otherwise indicated. Also, as used herein, the terms “wet” refers to relative percentages of the coating composition in a dispersion medium (e.g. water); and “dry” refers to the relative percentages of the dry coating composition prior to the addition of the dispersion medium. In other words, the dry percentages are those present without taking the dispersion medium into account. Wet admixture refers to the coating composition with the dispersion medium added. “Wet weight percentage”, or the like, is the weight in a wet mixture; and “dry weight percentage”, or the like, is the weight percentage in a dry composition without the dispersion medium. Unless otherwise indicated, percentages (%) used herein are dry weight percentages based on the weight of the total composition.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A cable comprising:
one or more conductors, each of the one or more conductors comprising:
an insulation layer surrounding the conductor; and
a nylon layer surrounding the insulation layer; and
a jacket layer surrounding the one or more conductors; and
wherein the cable is halogen-free and passes one or more of International Electrotechnical Commission (“IEC”) 612034-2 and IEC 60754-1-2.

2. The cable of claim 1 passes the Underwriter's Laboratory (“UL”) 1581 VW-1 flame test.

3. The cable of cable 1 passes Section 518 of NTC 2050 (Columbia).

4. The cable of claim 1 comprises between two to five conductors.

5. The cable of claim 1, wherein the insulation layers comprise one or more of a polyolefin polymer, a polyolefin copolymer, and a thermoplastic rubber.

6. The cable of claim 5, wherein the polyolefin polymer or polyolefin copolymer comprises an ethylene-based or propylene-based polyolefin polymer or polyolefin copolymer.

7. The cable of claim 1, wherein each of the insulation layers comprise a thickness of about 10 mm or less.

8. The cable of claim 1, wherein each of the nylon layers comprise one or more of nylon 6-6 and nylon 6.

9. The cable of claim 1, wherein each of the nylon layers comprise a thickness of about 1 mm or less.

10. The cable of claim 1, wherein the jacket layer comprise one or more of a polyolefin polymer, a polyolefin copolymer, and a thermoplastic rubber.

11. The cable of claim 10, wherein the polyolefin polymer or polyolefin copolymer comprises an ethylene-based or propylene-based polyolefin polymer or polyolefin copolymer.

12. The cable of claim 1 has a diameter is about 9 mm or less.

13. The cable of claim 1 has a minimum bending radius of about 4 times the overall diameter.

14. The cable of claim 1 has a maximum operating voltage of about 1000 volts or less.

15. The cable of claim 1 exhibits:
an ampacity of 20 amps at a temperature of about 60° C. and a maximum operating voltage of 600 volts when measured in accordance to UL 62 and 2556; and
a maximum pulling tension of 460 kg when measured in accordance to American Society for Testing and Materials (“ASTM”) B3 and UL 2556.

16. The cable of claim 1 has a weight of about 160 kg per kilometer.

17. A method of forming a cable comprising:
providing one or more conductors;
extruding an insulation layer around each of the one or more conductors;
extruding a nylon layer around each of the insulation layers;
applying a jacket layer substantially around the one or more conductors; and
wherein the cable is halogen-free and passes one or more of International Electrotechnical Commission (“IEC”) 612034-2 and IEC 60754-1-2.
